(19) United States
(12) Patent Application Publication
(10) Pub. No.: US 2017/0080311 A1
(43) Pub. Date: Mar. 23, 2017

(54) Assembly for Baseball Field Dugout Seating and for Baseball Equipment Storage

(71) Applicant: Brent L. Cain, Ellis, KS (US)

(72) Inventor: Brent L. Cain, Ellis, KS (US)

(21) Appl. No.: 15/372,063

(22) Filed: Dec. 7, 2016

(51) Int. Cl. A63B 60/60; B65D 25/28; B62B 1/12; A47C 7/42; B62B 5/06; B62B 5/08; B65D 43/16; A47C 7/00

(52) U.S. Cl. CPC A63B 60/60; B65D 43/16; B65D 25/2835; A47C 7/002; A47C 7/42; B62B 5/067; B62B 5/085; B62B 1/125; B65D 2525/288; B62B 2202/40

(57) ABSTRACT

An assembly for baseball dugout seating and for baseball equipment storage incorporating an upwardly opening vessel having a height, an upper end, and an interior space, the interior space having front and rear ends; a removable seat plate overlying the front end of the interior space; a plurality of lower brackets mounted within the rear end of the interior space; a plurality of upper brackets mounted within the rear end of the interior space; a plurality of bats having lengths greater than the upwardly opening vessel's height, each bat having an end cap, a barrel, a taper, and a handle, each bat's end cap being received by one of the lower brackets, and each bat's taper being received by one of the upper brackets; and a seat-comprising upwardly extensions of the bat handles from the upwardly opening vessel's upper end.

### FIELD OF THE INVENTION

This invention relates to baseball equipment and baseball field seating. More particularly, this invention relates to assemblies adapted for dually serving as baseball equipment storage, and for facilitating baseball field dugout seating.

All references herein to baseball fields and baseball equipment are intended to refer generally to softball fields and equipment and fast pitch fields and equipment.

### BACKGROUND OF THE INVENTION

Baseball field dugouts commonly include a fixed bench which is set at rearward position within the dugout. Commonly, such benches are positioned excessively rearwardly from the dugout's front fence. In such dugouts, baseball equipment, such as baseball bats, baseball mitts, batting gloves, bat weights, caps, catcher's equipment, knee pads, shin pads, and the like, are stored and kept in a disorderly fashion in the dugout. Commonly, such equipment items are placed upon the dugout's floor between the bench and the forward fence. In many circumstances during a competitive baseball game, it is desirable that the players move attentively to a forward position within the dugout. However, the dugout's common rearward positioning of the bench combined with placements of equipment on the dugout floor in front of the bench combine to interfere with such desirable player positioning.

The instant inventive assembly for baseball dugout seating and for baseball equipment storage, solves or ameliorates problems discussed above by providing a specially configured vessel or container capable of dually serving for storage of baseball equipment and for seating of baseball players.

### BRIEF SUMMARY OF THE INVENTION

A first structural component of the instant inventive assembly for baseball dugout seating and for baseball equipment storage comprises an upwardly opening vessel having a rear wall, a front wall, lateral or left and right walls and a floor. In a preferred embodiment, the vessel has a height approximately 18 inches. Also in a preferred embodiment, the upwardly opening vessel is composed of durable plastic. The invention's vessel component necessarily defines an interior space having upper, forward, and rearward ends.

A further structural component of the instant inventive assembly comprises a removable, and preferably hinged or pivoting seat plate which is fitted to overlie and cover at least a frontward portion of the vessel's interior space. In the preferred embodiment, the seat plate is composed of durable plastic and has a cushioned upper surface.

Further structural components of the instant inventive assembly comprise upper and lower pluralities of bat brackets which are fixedly mounted within the upwardly opening vessel, such brackets preferably being positioned at the interior space's rearward end. The invention's upper and lower bat brackets are preferably fitted and configured for holding and storing a laterally extending array of vertically oriented baseball bats, the bat brackets preferably being adapted for upwardly extending the bats' handles from the rearward end of the seat plate. Such upward bat handle extensions advantageously constitute and function together as a seat back.

In use of the instant inventive assembly for baseball dugout seating and for baseball equipment storage, various items of baseball equipment such as a baseball mitt, batting gloves, shin pads, etc., may be forwardly stored within the interior space of the upwardly opening vessel. Upon pivoting closure of the assembly's seat plate component, a baseball player may conveniently seat himself or herself upon the preferably cushioned upper surface of the seat plate. Provided that the above described lateral array of bats is stored and supported within the invention's bat bracket components, such seated player may ergonomically recline rearwardly, allowing the bats' upwardly extending handles to forwardly impinge against the player's back in the manner of a seat back.

Accordingly, objects of the instant invention include the provision of a assembly for baseball dugout seating and for baseball equipment storage which incorporates structures as described above, and which arranges those structures in the manners described above for the performance of the beneficial functions described above.

Other and further objects, benefits, and advantages of the instant invention will become known to those skilled in the art upon review of the Detailed Description which follows, and upon review of the appended drawings.

### BRIEF DESCRIPTION OF THE DRAWINGS

FIG. 1 is a perspective view of a preferred embodiment of the instant inventive assembly for baseball dugout seating and for baseball equipment storage.

FIG. 2 is a sectional view as indicated in FIG. 1.

FIG. 3 is a magnified partial view of the structure of FIG. 2, as indicated in FIG. 2.

FIG. 4 is an alternative magnified partial view of the structure of FIG. 2, as indicated in FIG. 2.

FIG. 5 presents a side view of the structure of FIG. 1, the view of FIG. 5 including a cut away showing stored items of baseball equipment and further showing in dashed lines a baseball player seated upon the assembly.

FIG. 6 redepicts the structure of FIG. 1 with baseball bats removed.

FIG. 7 presents an alternative configuration of the structure depicted in FIG. 6.

FIG. 8 presents a further alternative configuration of the structure depicted in FIG. 6.

### DETAILED DESCRIPTION OF PREFERRED EMBODIMENTS

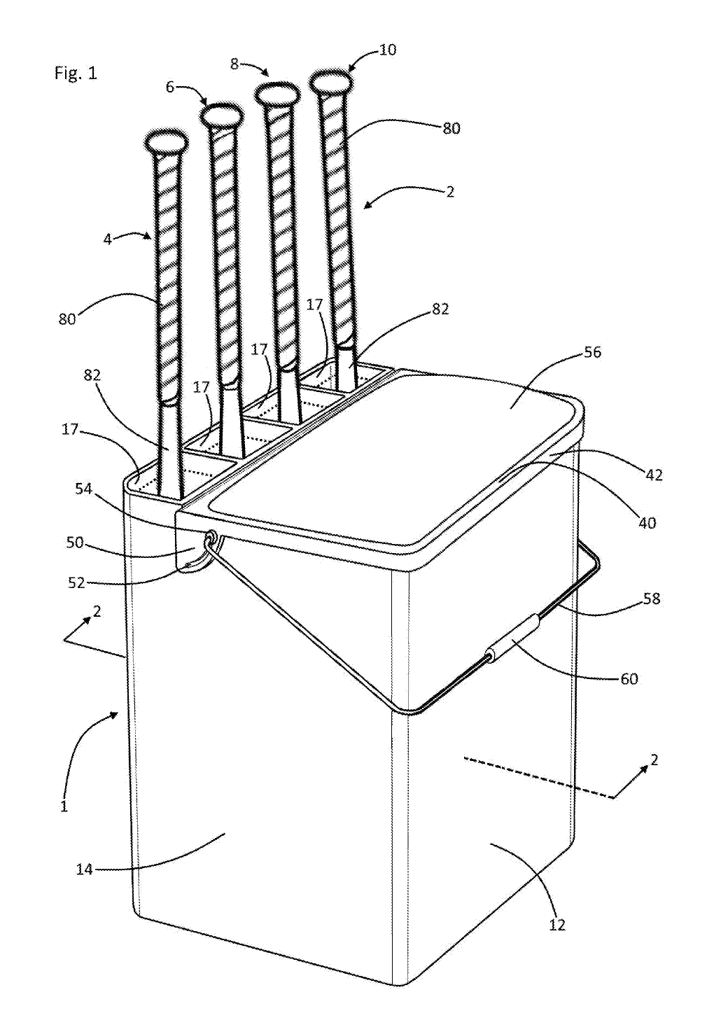

Referring now to the drawings and in particular to Drawing FIGS. 1, 2, 5, 6, and 7, a preferred embodiment of the instant inventive assembly for baseball dugout seating and for baseball equipment storage is referred to generally by Reference Arrow 1. The assembly 1 comprises an upwardly opening vessel having a right or lateral wall 14, a left or oppositely lateral wall 16, a front wall 12, a rear wall 18, and a floor 13,15. A laterally extending interior wall 22 in combination with the right and left walls 16 and 14, the front wall 12, and the floor 13,15 forms and defines a forward storage space 20. Such space 20 may be advantageously used for storing items of baseball equipment such as baseballs, baseball mitts, and batting gloves 102.

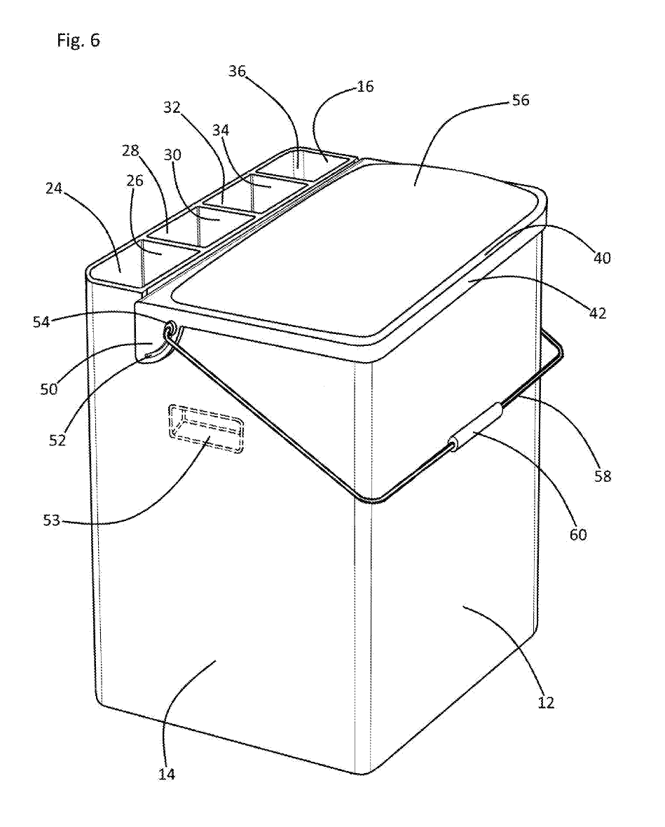

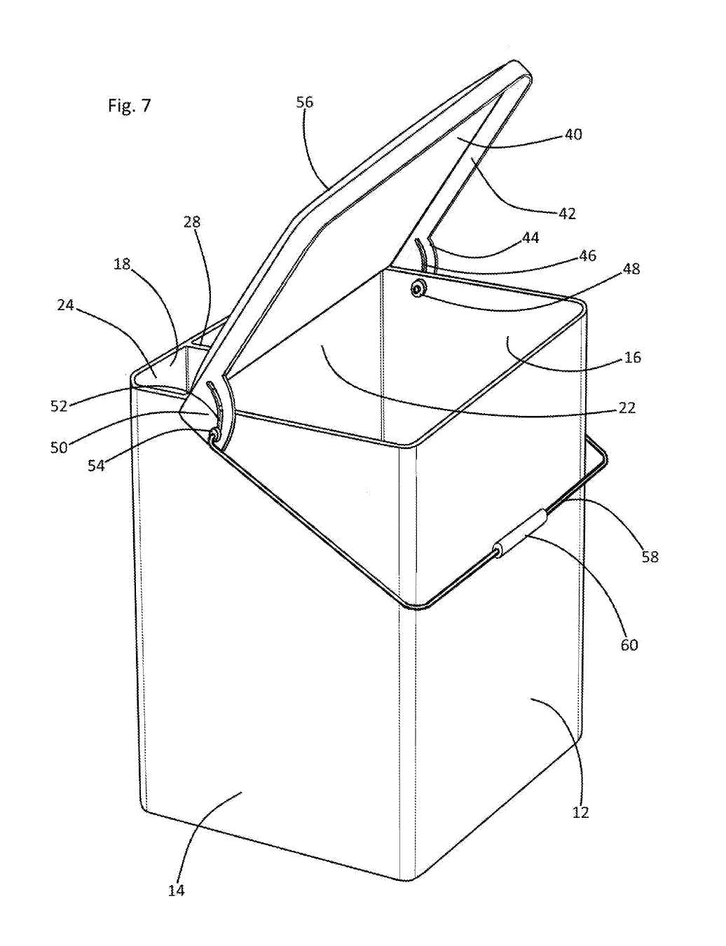

A removable, and preferably pivoting, seat plate 40 overlies and covers the interior space 20, such seat dually functioning as a lid component. The seat plate 40 is preferably composed of durable plastic, and includes a peripheral flange 42 which seals the interior 20 and provides additional rigidity to the seat plate 40. Cushioning 56 may be adhesively attached to the upper surface of the seat plate 40 to enhance seating comfort. In a preferred embodiment, left and right slotted ears 44 and 50 extend downwardly from rearward ends of flange 42. Such extensions 44 and 50 have curved slots 46 and 52 which slidably engage circular “T” head elements 48 and 54 which are rigidly mounted to walls 16 and 14. Such hinge components 44,46,48, and 50,52,54, facilitate pivoting opening and closing movements of the seat plate 40 between the closed position depicted in FIG. 6 and the upwardly removed opened position of FIG. 7. The hinge configuration depicted in FIGS. 6 and 7 is intended as being representative of other commonly known and acceptably substituted hinges such as pin and sleeve hinges.

Further structural components of the instant inventive assembly comprise pluralities of bat securing and positioning brackets which are adapted for both vertically orienting a series of bats such as bats 4, 6, 8, and 10, and for arranging the bats in a laterally extending series at the rearward end of seat plate 40.

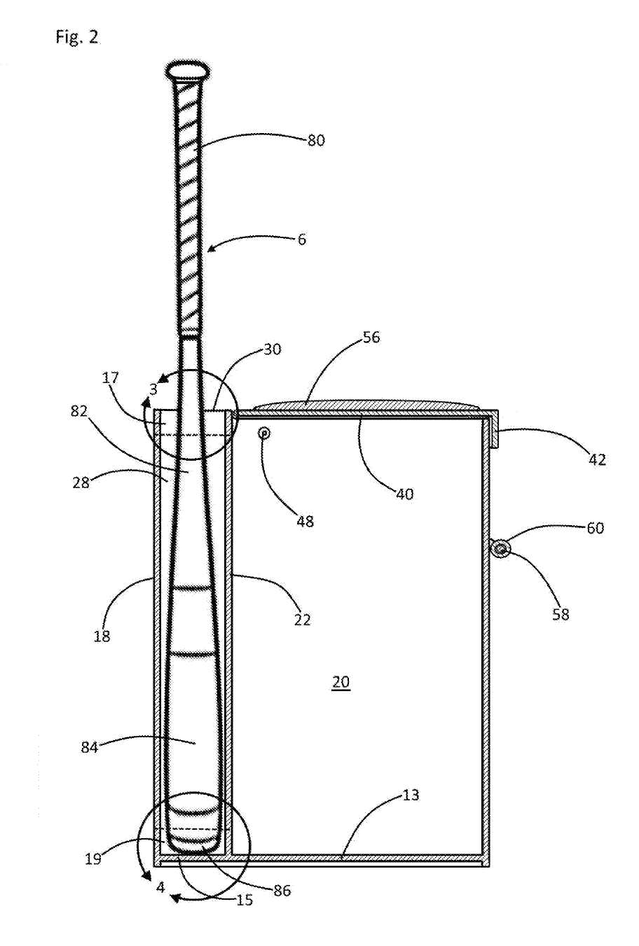

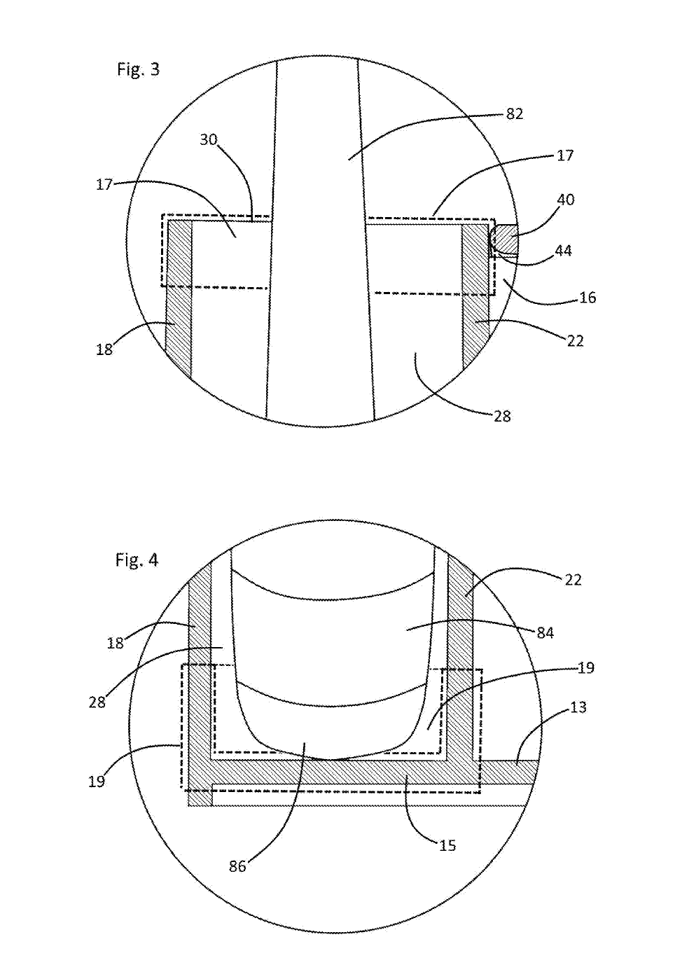

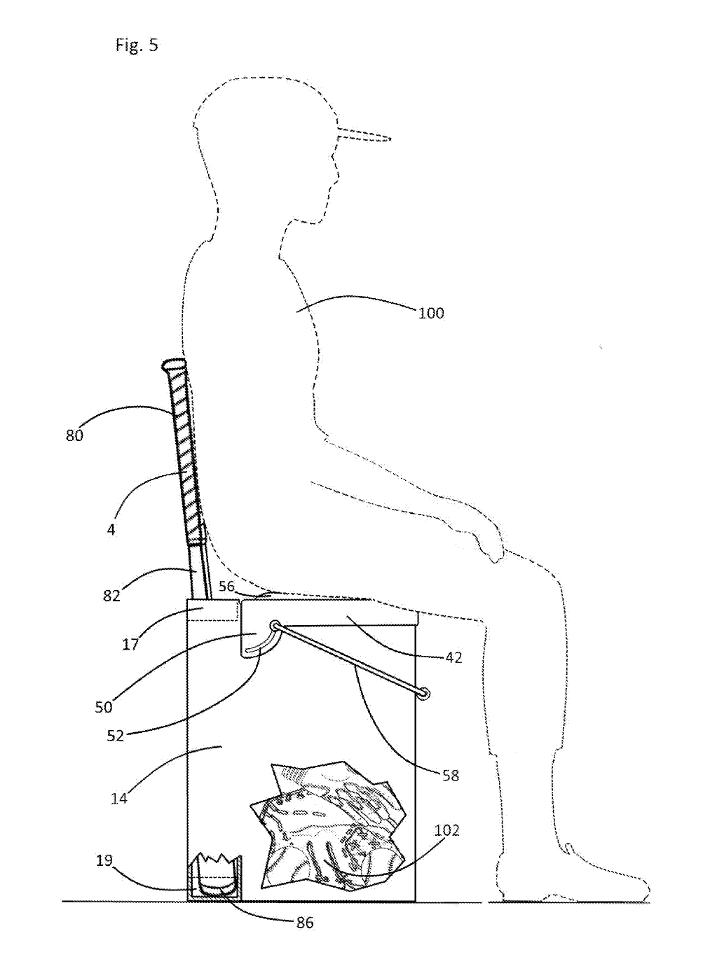

In a preferred embodiment, the invention's bat brackets comprise a lower plurality of brackets and an upper plurality of brackets. Suitable embodiments of the lower bat securing brackets are depicted in Drawing FIGS. 2-7, such brackets comprising combinations of rearward floor portions 15, lower portions of the partitioning wall 22, lower portions of the rear wall 18, lower portions of longitudinally extending partitioning walls 26, 30, and 34, and lower rear portions of side walls 14 and 16. Such lower wall portions and floor section 15 combinations advantageously form and define a lateral series of upwardly opening concavities 19 which are designated in dashed lines. Each such upwardly opening concavity configured lower bat bracket 19 may nestingly receive and may secure the cap end or lower end 86 of one of the baseball bats 4, 6, 8, and 10. Suitably, such concave bat bracket may additionally nestingly receive the bat's barrel portions 84. The lower bat brackets 19, as represented in dashed lines in FIGS. 2-5 are intended to be representative of other suitably substituted lower bat brackets, such as bat end receiving loops or sleeves.

In the preferred embodiment, the walls among the rearward wall 18, the lateral partitioning wall 22, and the right and left walls 14 and 16, and the longitudinally extending partitioning walls 26, 30, and 34 extend upwardly from the lower end bat brackets 19 to form at the upper end of the vessel a lateral array of upper bat brackets 17. Such upper bat brackets 17 may laterally engage taper portions 82 of the bats 4, 6, 8, and 10, such engagements securing the bats in their upwardly oriented and upwardly extending configurations. The dashed line depictions of the upper bat brackets 17 are considered to be representative of other suitably substituted bat securing bracket configurations such as loops or sleeves.

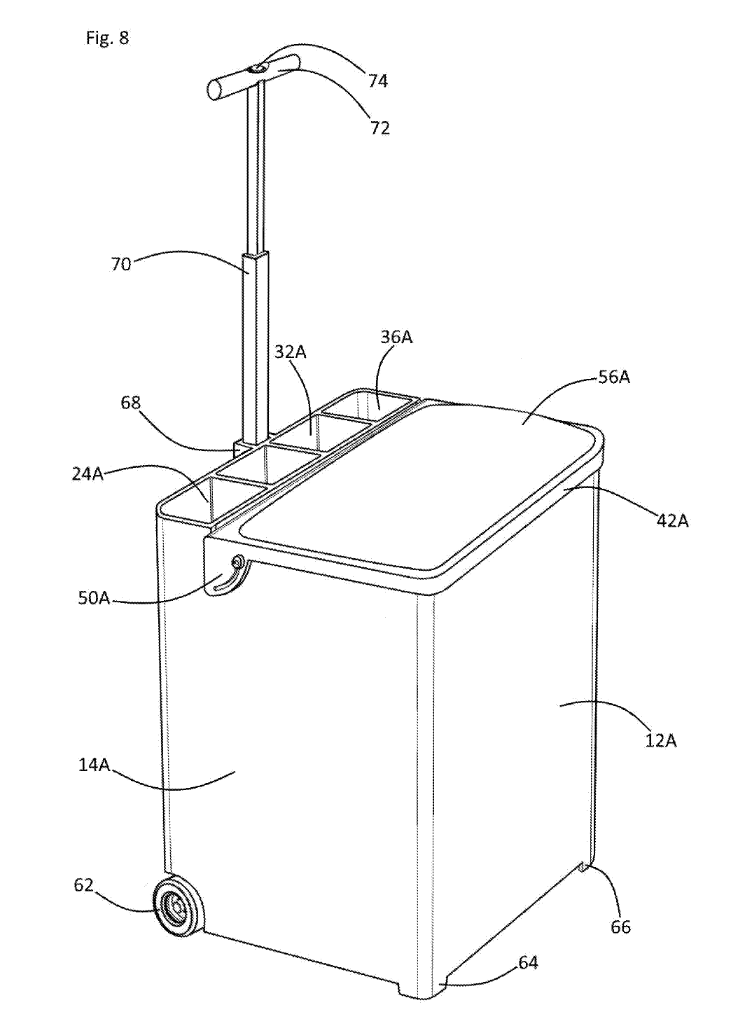

Referring in particular to FIGS. 6 and 7, a steel bar stock “U” loop 58 has left and right arm distal ends which are formed integrally with the “T” slides 48 and 54, such “U” loop having a cylindrical handle 60. Upon closure of the lid 40, handle 60 and “U” loop 58 may be pivotally moved upwardly for handle carriage of the seating and storage assembly 1. Alternative carry means in the form of right 53 and left (not within view) finger receiving detents or depressions may be suitably incorporated into side walls 14 and 16 in place of loop handle 58. Alternative carry means are depicted in FIG. 8, wherein all structures identified by reference numerals having a suffix “A” are substantially identical to similarly numbered structures appearing in FIGS. 1-7. In the FIG. 8 carry means alternative, wheels 62 are rotatably mounted to the lower rearward end of the assembly's vessel component, and leveling feet 64 and 66 extend downwardly from the vessel's forward end. A telescoping pull handle 70 is slidably mounted within a sleeve 68, such handle having a “T” handle portion 72 and a release latch button 74.

Upon closure of the lid 40, bats 4, 6, 8, and 10 may be respectively inserted into and stored within rear storage spaces 24, 28, 32, and 36. Such mode of bat storage advantageously upwardly extends the bats' handles 80 in a seat back forming array 2. Thereafter, a baseball player 100 may be seated upon the cushion 56 of seat plate 40. Thereafter, the player 100 may slightly recline rearwardly, causing his or her back to rearwardly impinge against the bats' handles 80. Such reclining motion and back impingements simultaneously drives the bats' taper portions 82 rearwardly against the upper bat brackets 17 while levering the lower cap ends 86 of the bats forwardly against the lower bat brackets 19. In such levering action, the upper brackets function as a fulcrum which actuates the retaining actions of the lower brackets 19. Counter-torque imposed by the brackets 17 and 19 to the bats' tapers 82 and caps 86 advantageously meets and resists the player's back reclining motion, and allows the bat's handles 80 to constitute and to effectively function as a seat back 2.

While the principles of the invention have been made clear in the above illustrative embodiment, those skilled in the art may make modifications to the structure, arrangement, portions and components of the invention without departing from those principles. Accordingly, it is intended that the description and drawings be interpreted as illustrative and not in the limiting sense, and that the invention be given a scope commensurate with the appended claims.

The invention hereby claimed is:

1: An assembly for baseball dugout seating and for baseball equipment storage, said assembly comprising:
(a) an upwardly opening vessel having a rear wall, a height and an upper end, the upwardly opening vessel further having an interior space, said space having front and rear ends;
(b) a removable seat plate overlying the front end of the interior space;
(c) an upper plurality of bat brackets fixedly mounted within the rear end of the interior space; and
(d) a lower plurality of bat brackets fixedly mounted within the rear end of the interior space.

2: The assembly of claim 1 wherein each lower bat bracket comprises an upwardly opening concavity.

3: The assembly of claim 2 wherein each upwardly opening concavity has a rear wall, the upwardly opening vessel's rear wall comprising the upwardly opening concavities' rear walls.

4: The assembly of claim 3 wherein each upwardly opening concavity has a pair of lateral walls.

5: The assembly of claim 4 wherein each wall among the upwardly opening concavities' rear and lateral walls extends upwardly to the vessel's upper end, the upper bat brackets comprising said upward wall extensions.

6: The assembly of claim 5 wherein the removable seat plate is hingedly mounted upon the upwardly opening vessel.

7: The assembly of claim 6 further comprising a cushion fixedly attached to the removable seat plate.

8: The assembly of claim 6 further comprising carry means fixedly attached to the upwardly opening vessel.

9: The assembly of claim 8 wherein the carry means comprise a loop handle or a wheel and pull handle combination.

10: The assembly of claim 1 comprising a plurality of bats having handles, and further comprising a seat back extending upwardly from the vessel's rearward end, the seat back comprising the bat handles.

11: The assembly of claim 10 wherein each bat is engaged by one of the upper bat brackets and is engaged by one of the lower bat brackets.

12: The assembly of claim 11 wherein each lower bat bracket comprises an upwardly opening concavity.

13: The assembly of claim 12 wherein each upwardly opening concavity has a rear wall, the upwardly opening vessel's rear wall comprising the upwardly opening concavities' rear walls.

14: The assembly of claim 13 wherein each upwardly opening concavity has a pair of lateral walls.

15: The assembly of claim 14 wherein each wall among the upwardly opening concavities' rear and lateral walls extends upwardly to the vessel's upper end, the upper bat brackets comprising said upward wall extensions.

16: The assembly of claim 15 wherein the removable seat plate is hingedly mounted upon the upwardly opening vessel.

17: The assembly of claim 16 further comprising a cushion fixedly attached to the seat plate.

18: The assembly of claim 17 further comprising carry means fixedly attached to the upwardly opening vessel.

19: The assembly of claim 18 wherein the carry means comprise an assembly selected from the group consisting of pivoting loop handles, wheel and pull handle combinations, and side wall recesses.
